(19) United States
(12) Patent Application Publication
(10) Pub. No.: US 2003/0135390 A1
(43) Pub. Date: Jul. 17, 2003

(54) Interactive system for providing healthcare information

(76) Inventors: Kevin O'Brien, Cincinnati, OH (US); Mark Daly, Cincinnati, OH (US)

Correspondence Address: Barry L. Kelmachter, BACHMAN & LaPOINTE, P.C., Suite 1201, 900 Chapel Street, New Haven, CT, 06510-2802, US

(21) Appl. No.: 10/053,436

(22) Filed: Jan. 17, 2002

(51) Int. Cl. G06F 17/60

(52) U.S. Cl. 705/2

(57) ABSTRACT

In accordance with the present invention, an interactive system for providing information to individuals in a medical setting is provided. The system broadly comprises at least one video display unit located within the medical setting, a list of programs available for viewing by the individual, a manual device for entering a program number selected from the list, an electronic device containing a plurality of video files connected to the at least one video display unit so that a program selected by the individual using the manual device is provided by the electronic device to the at least one display unit, and an electronic device external or internal to the medical setting for changing and updating the video files on the electronic device. In still another aspect of the present invention, a method for gathering information about health care programs being viewed by individuals in a medical setting is provided.

### BACKGROUND OF THE INVENTION

The present invention relates to an interactive system and method for providing healthcare information to individuals in a medical setting. The present invention also relates to a method for gathering information about health care programs viewed by individuals.

Cost-effective healthcare has become the goal of many in the healthcare field. One way to achieve cost savings is to better educate individuals about health conditions, current treatments, and available medicines. Currently, there are a number of systems that attempt to provide individuals with healthcare information and health care products. For example, there are cable television channels devoted to providing viewers with healthcare information. Some doctor's reception areas contain a television tuned to a healthcare channel on which health care programming is displayed. There are television and magazine advertisements about available prescription medicines which reach individual homes. Still further, there is a great deal of information on the Internet about medical conditions, treatments, and available medicines.

Despite this seemingly large supply of information, none of the available information is presented in a way which effectively educates an individual about a particular condition, a particular treatment, and a particular medicine to be used to treat a particular condition at a time and place where questions can be answered by a health professional. The presence of a health professional allows a degree of individual attention not often achieved by most health content media.

Other reasons why individuals are not being adequately educated about medical conditions include (1) the display of a program directed to a particular delicate or embarrassing condition, such as a program about male impotence, in a public forum, such as a doctor's reception area; (2) the program is being viewed at a time well before any scheduled physician contact; (3) distractions while the program is being viewed; and (4) condition specific programming is unavailable.

Thus, there remains a need for a better system for providing healthcare information to individuals who seek specific information to their specific health problem.

### SUMMARY OF THE INVENTION

Accordingly, it is an object of the present invention to provide an improved system and method for providing relevant healthcare information to individuals.

It is yet a further object of the present invention to provide a system and a method as above which allows an individual to select one or more healthcare topics of interest.

It is still a further object of the present invention to provide a system and a method as above which allows an individual to have access to trained healthcare personnel to respond to healthcare questions resulting from a viewing of a particular healthcare program.

It is yet a further object of the present invention to provide a system and a method as above which allows manufacturers of medicines and other healthcare products to provide individuals with information about available medicines and healthcare products.

The foregoing objects are attained by the system and method of the present invention.

In accordance with one aspect of the present invention, an interactive system for providing information to individuals in a medical setting is provided. The system broadly comprises at least one video display unit located within a medical setting, such as a physician examination/consultation room or hospital or pharmacy setting, a list of programs available for viewing by the individual, a manual device for entering a program number selected from the list, an electronic device containing a plurality of video files connected to at least one video display unit so that a program selected by the individual using the manual device is provided by the electronic device to the video display unit(s), and means external or internal to the medical setting for changing and updating the video files on the electronic device.

In another aspect of the present invention, an interactive method for providing healthcare information to individuals is provided. The method broadly comprises the steps of locating a video display unit within a medical setting, connecting an electronic device containing a plurality of video files to the video display unit, providing a list of the video files available for viewing by the individual and a device for accessing the video files, and displaying a video file selected by the individual.

In still another aspect of the present invention, a method for gathering information about healthcare programs being viewed by individuals in a medical setting is provided. The method broadly comprises locating at least one video display unit within a medical setting, connecting an electronic device containing a plurality of video files to the video display unit, providing a list of the video files to an individual and a device for accessing the video files, displaying a video file selected by the individual, and maintaining a log of each selected video file played.

Other details of the system and the methods of the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 is a schematic representation of a system for providing healthcare information to individuals in a medical setting; and

FIG. 2 is a schematic representation of a tablet containing a list of available programming and a manual access device.

### DETAILED DESCRIPTION OF THE PREFERRED EMBODIMENY(S)

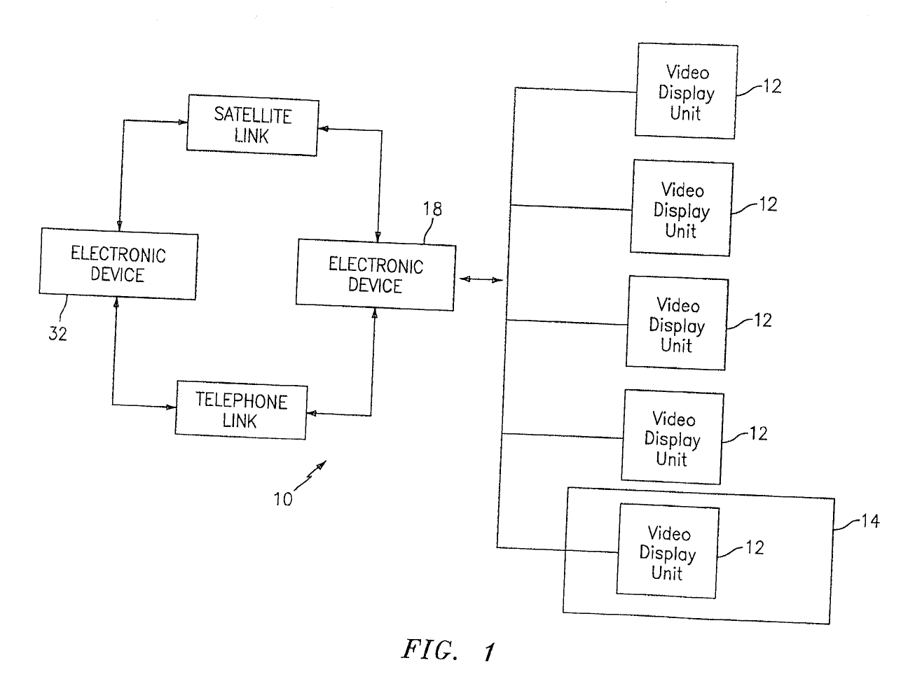

Referring now to the drawings, FIG. 1 illustrates an interactive system 10 for disseminating healthcare information to individuals. The healthcare information which is disseminated may include health condition education, health condition medical news, medical illustrations to be used by a physician to discuss a medical condition with an individual, product/drug education, and other appropriate healthcare information.

The system 10 differs from other systems in that a video display unit 12 is placed in each examining/consultation room 14 in a medical setting. Placing the video display unit 12 in such a location has a number of advantages. These include the individual being able to watch a program about a medical condition or treatment which would be embarrassing if the individual had to watch it in a more public setting such as a doctor's reception area. Further, the individual can watch the program with a medical service provider and thus have the ability to ask questions during or immediately after the viewing of the program. Yet another advantage is the ability to educate the individual such as how or when to take a particular a drug or product that a doctor will prescribe.

The video display unit 12 may comprise any suitable display unit known in the art, such as a television or the like. The video display unit 12 preferably has sensor means for receiving an infrared signal from a manual input device 16 and for transmitting the received infrared signal to a remote electronic device 18, such as a server, containing a plurality of video files. A suitable video display unit for use in the system is a Philips PB7013C monitor having a 15″ display screen and built-in stereo speakers. The connection between the video display unit 12 and the remote electronic device 18 may be a cable connection or may be a wireless connection.

Since a typical medical setting has multiple examination/consultation rooms, a plurality of video display units 12 will be connected to the electronic device 18. Therefore, the electronic device 18 is preferably located in the medical setting externally of any of the examination/consultation rooms 12.

The electronic device 18 may be any suitable electronic device known in the art on which a number of video files in a desired format can be stored. The electronic device 18 also preferably has the following capabilities. First, the electronic device 18 should allow access to any video file stored on it within 1 to 3 seconds. Second, the electronic device 18 should be capable of allowing a simultaneous display of the same video file. Third, the electronic device 18 should be capable of maintaining a log of each video file shown and the date and time of its showing. Fourth, the electronic device 18 should be capable of being accessible from a remote location so that the video files on the electronic device 18 may be updated and the log maintained by the electronic device 18 may be downloaded.

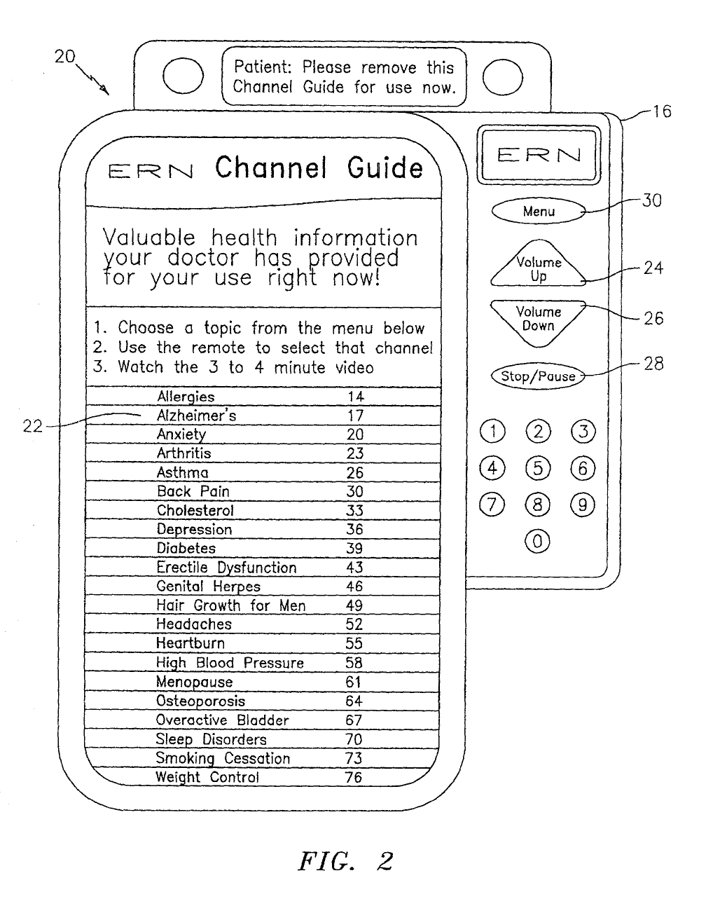

To access the video files stored on the electronic device 18, an individual is provided with a user interface 20 which contains a list 22 of available programs in the video files and their channels and the manual input device 16 which is preferably an infrared remote control. As can be seen from FIG. 2, the remote control 16 has a numeric keypad 21 for entering the number associated with a particular video file or program. The remote control 16 also has volume up and volume down buttons 24 and 26 respectively and a stop/pause button 28. While it is preferred to provide the individual with a printed list of available programs, it is also possible to display the list of available programs on screen. To this end, the remote control 16 may also be provided with a menu button 30. If desired, the remote control 16 may, in lieu of the keypad, have a touchpad or a keyboard. It may also have a mouse if desired.

In operation, after the individual selects a program by depressing the keys of the keypad 21, a signal, such as an infrared signal, or other non-terrestrial connection is transmitted by the remote control 16 to the video display unit 12 which in turn transmits the signal or other non-terrestrial connection to the electronic device 18. The electronic device 18 then transmits the selected video file to the video display unit 12 in the examination/consultation room 14. Each program may last for a desired time period such as three to four minutes.

While it is preferred to mount the list 22 of available programs and the remote control device 16 to the user interface 20 for convenience sake, the remote control device 16 could be separated from the user interface 20 if desired.

As previously mentioned, the video files on the electronic device 18 need to be updated periodically, for example once a week or month. To this end, the electronic device 18 may be connected to an external device 32, such as an electronic device or computer, located remotely from the medical setting. The electronic device 18 may be connected to the external device 32 using any suitable means known in the art. For example, the electronic device 18 may be connected to the external device 32 via a satellite downlink/uplink system. Alternatively, the electronic device 18 may be connected to the external device 32 via telephone lines, terrestrial lines, or two-way satellite communication. If desired, the external device may be a portable electronic device.

In addition, to receiving updated video files from the external device 32, the electronic device 18 is preferably programmed to periodically download the contents of the log maintained by it to the external device 32 upon request by the external device. The external device 32 may be programmed to have means for accessing the data maintained in the log and means for storing the data which has been downloaded from the electronic device 18.

The downloaded log data may then be analyzed to determine which healthcare programs are being watched. The information gathered from the log data may be stored on the electronic device 32 for further study and evaluation. Since some of the programs will be for drug and other medical related products and other of the programs will contain at least one advertisement, the log may be analyzed to determine the number of times such programs were viewed and the amount of advertising monies to be paid by each manufacturer of the viewed drug or other medical related product programs and by each advertiser.

The external device 32 may also be used to periodically download new or updated software programming to the electronic device 18.

The system 10 may further include a keyboard and a monitor associated with the electronic device 18. If desired, a printer may also be associated with the electronic device 18. The keyboard may be utilized to interact with the electronic device 18 or may be used to download the contents of the log onto a disk or CD-Rom or to print the contents of the log.

As can be seen from the foregoing discussion, an interactive multimedia education system for use by individuals/patients within a medical setting has been provided. The system provides media content and delivery in four principal areas. First, there is programming related to health conditions which may be approximately three minute segments plus 30 to 60 second ads. Each health condition program may include what the condition is and its incidence, signs and symptoms of the health condition, how the condition is diagnosed, and treatment options. Second, there is programming related to product education. This programming may be several minute segments produced by a sponsor or an agency. Further, this programming may contain information as to what a particular medication is for and how it works, how to take the medication, what the common side effects of the medication are, and when to call your doctor about this medication. Third, there is programming related to recent or historical medical news. Each of these programs may be a one to five minute segment with ads. The programming may contain information such as news items related to one of the health conditions, reinforcement of the importance of the condition, health tips relevant to the condition selected, and a bumper to watch another segment such as a health condition segment. A principal intent of this type of programming is to draw viewers into watching a health condition segment that they might not otherwise have watched, or to provide additional, more current programming for patients making multiple visits to the medical setting. Fourth, the programming may consist of medical illustrations or videos which a doctor may use following an individual's examination/consultation to explain a medical condition.

The system of the present invention has the advantage of being able to fill the time that an individual normally spends in a medical setting waiting for a doctor in a very educational way. After being ushered into the medical setting, the individual may be handed the user interface 20 with the remote control 16 and the list 22 of available programs. If the individual has come to the medical setting for a particular condition, such as treatment of an allergy or influenza, he/she may then view programming related to that condition.

If desired, the electronic device 18 may be programmed to automatically turn on and turn off the system at specific times during the day. By doing this, the system 10 does not have to be left on for 24 hour periods.

It is apparent that there has been provided in accordance with the present invention an interactive system for providing healthcare information to individuals which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. An interactive system for providing information to patients in a medical setting comprising:
at least one video display unit located within a medical setting;
a list of available programs for viewing by a patient;
a manual device for entering a program number selected from said list by said patient;
an electronic device containing a plurality of video files connected to said at least one video display so that a program selected by said patient using said manual device is provided by said electronic device to said at least one video display unit; and
means for changing and updating said video files on said electronic device.

2. An interactive system according to claim 1, wherein said changing and updating means is external to said medical setting.

3. An interactive system according to claim 1, wherein said changing and updating means is internal to said medical setting.

4. An interactive system according to claim 1, wherein said electronic device maintains a log of each program selected by said viewer.

5. An interactive system according to claim 4, wherein said changing and updating means comprises means for accessing data in said log maintained by said electronic device.

6. An interactive system according to claim 4, further comprising said changing and updating means communicating with said electronic device via a satellite link.

7. An interactive system according to claim 4, further comprising said changing and updating means communicating with said electronic device via at least one of a telephone line and a terrestrial line.

8. An interactive system according to claim 4, wherein said changing and updating means comprises an electronic device located at a location remote from said medical setting.

9. An interactive system according to claim 1, wherein said plurality of video files on said electronic device include video programs about at least one of medical news, medical illustrations, product education, medical conditions, and healthcare information.

10. An interactive system according to claim 9, wherein at least some of said video programs contain advertisements for medical products and instructions for taking such medical products.

11. An interactive system according to claim 1, wherein said list of available programs comprises an on-screen display of said available programs.

12. An interactive system according to claim 1, further comprising a user interface containing said list of available programs and said manual device.

13. An interactive system according to claim 12, further comprising said manual device comprising a remote control device having a keypad, touchpad, mouse or keyboard.

14. An interactive system according to claim 1, further comprising said at least one video display unit comprising at least one television monitor located within a patient examining room in said medical setting.

15. An interactive system according to claim 1, further comprising said at least one video display unit comprising at least one television monitor located within a hospital.

16. An interactive system according to claim 1, further comprising said at least one video display unit comprising at least one television monitor located in a pharmacy setting.

17. An interactive system according to claim 14, wherein said medical setting has a plurality of patient examining/consultation rooms and said system includes a television monitor in each of said examining/consultation rooms.

18. An interactive system according to claim 17, further comprising each said television monitor being connected to said electronic device.

19. An interactive system according to claim 1, further comprising a plurality of video display units in said medical setting and said electronic device having a capability to provide the same program content to each of said video display units.

20. An interactive system according to claim 1, wherein said list of available programs comprises a list of channels and a program associated with each of said channels.

21. An interactive program according to claim 1, wherein said manual device comprises a device for generating an infrared signal and said at least one video display unit has means for receiving said infrared signal and for transmitting said infrared signal to said electronic device.

22. An interactive system according to claim 1, having an automatic turn-on feature and an automatic turn-off feature.

23. An interactive method for providing healthcare information to an individual, said method comprising the steps of:
locating a video display unit within an examination/consultation room in a medical setting;
connecting an electronic device located externally of said examination room and containing a plurality of video files to said video display unit;
providing a list of said video files available for viewing by said individual and a device for accessing said video files; and
displaying a video file selected by said individual.

24. A method according to claim 23, further comprising:
said locating step comprising locating a plurality of video display units in a plurality of examination/consultation rooms; and
said connecting step comprises connecting said electronic device to each of said video display units.

25. A method according to claim 23, further comprising storing on said electronic device a plurality of video files relating to health conditions, medical illustrations, healthcare products and medicines, and medical news.

26. A method according to claim 23, further comprising updating said video files on said electronic device from another electronic device located remote from said medical setting.

27. A method according to claim 26, wherein said updating step comprises updating said video files via a satellite link.

28. A method according to claim 26, wherein said updating step comprises updating said video files via a telephone line.

29. A method according to claim 26, wherein said updating step comprises updating said video files via a portable electronic device.

30. A method according to claim 23, further comprising maintaining a log of video files viewed by said individuals on said electronic device.

31. A method according to claim 30, further comprising periodically downloading information maintained in said log to a remote device for analysis of said information.

32. A method according to claim 23, wherein said list and device providing step comprises providing a user interface containing said list of available video files and a remote control to said individual.

33. A method for gathering information about health care programs viewed by patients in a medical setting comprising:
locating at least one video display unit within at least one examination/consultation room in said medical setting;
connecting an electronic device containing a plurality of video files to each said video display unit;
providing a list of said video files to a patient and a device for accessing said video files;
displaying a video file selected by said patient; and
maintaining a log of each selected video file on said electronic device.

34. A method according to claim 33, further comprising gathering information about viewed programs by accessing said log via another electronic device.

35. A method according to claim 34, further comprising utilizing said gathered information to compute an amount due from at least one of advertisers and sponsors.
